(19) United States
(12) Patent Application Publication
(10) Pub. No.: US 2024/0388660 A1
(43) Pub. Date: Nov. 21, 2024

(54) NETWORK NODE, INFORMATION PROCESSING SYSTEM, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Xiao SHAO, Kawasaki-shi (JP); Kazuya OKADA, Tokyo (JP); Naoya KANEKO, Tokyo (JP); Jing MA, Yokohama-shI (JP); Takuya ASAOKA, Tokyo (JP)

(73) Assignee: TOYOTA JIDOSHA KABUSHIKI KAISHA, Toyota-shi (JP)

(21) Appl. No.: 18/417,421

(22) Filed: Jan. 19, 2024

(30) Foreign Application Priority Data
May 15, 2023 (JP) 2023-079912

(51) Int. Cl. H04M 15/00

(52) U.S. Cl. CPC H04M 15/41; H04M 15/8214; H04W 84/042

(57) ABSTRACT

A network node that configures a wireless communication network, comprises a processor configured to execute: receiving a charging data request; and generating a charging data record in response to receiving the charging data request. The charging data record comprises a data identifier of data provided by a data providing apparatus.

### CROSS-REFERENCE TO RELATED APPLICATION

This application claims priority to Japanese Patent Application No. 2023-079912 filed on May 15, 2023, incorporated herein by reference in its entirety.

### BACKGROUND

Traditional systems describe interactions between a user mobile terminal and a mobile system to allow the mobile device to operate in different locations.

### SUMMARY

The present disclosure provides a technology capable of granting an incentive to a user that has contributed to data provision. In some examples, a server may register user information of a user mobile terminal participating in information provision process and search for a user participating in the provision of information. The server may transmit a request for information provision to the user terminal of the corresponding user in exchange for the incentive. As a result, it becomes possible to collect information in exchange for granting the incentive. Other methods and systems are also described.

In some examples, a network node of the system is described according to a first aspect of the present disclosure to help configure a wireless communication network. The network node comprises a processor. The processor is configured to receive a charging data request; and generate a charging data record in response to receiving the charging data request; and the charging data record comprises a data identifier of data provided by a data providing apparatus.

An information processing system according to a second aspect of the present disclosure comprises: a network node; and a billing domain. The network node comprises a first processor configured to execute: receiving a charging data request; generating a charging data record in response to receiving the charging data request; and transmitting the charging data record to the billing domain. The billing domain comprises a second processor configured to execute: receiving the charging data record; and demanding processing or paying processing based on the charging data record; and the charging data record comprises an identifier of data provided by a data providing apparatus.

An information processing method according to a third aspect of the present disclosure is executed by a network node configuring a wireless communication network. The information processing method comprises: receiving a charging data request; and generating a charging data record in response to receiving the charging data request, wherein the charging data record comprises a data identifier of data provided by a data providing apparatus.

A non-transitory storage medium according to a fourth aspect of the present disclosure stores instructions that are executable by a computer and that cause the computer to perform the method according to the third aspect of the present disclosure.

According to the aspect of the present disclosure, it becomes possible to grant the incentive to the user that has contributed to the data provision and hence facilitate data provision that is more useful.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram exemplifying components of a wireless communication system, in accordance with some embodiments of the disclosure;

FIG. 2 is a diagram describing a charging function (CHF), in accordance with some embodiments of the disclosure;

FIG. 3A is a diagram showing a configuration example of an information processing apparatus capable of operating as an NF, in accordance with some embodiments of the disclosure;

FIG. 3B is a diagram showing a configuration example of an information processing apparatus capable of operating as a user terminal, in accordance with some embodiments of the disclosure;

FIG. 4A is a sequence diagram relating to collection and provision of sensing measurement data, in accordance with some embodiments of the disclosure;

FIG. 4B is a sequence diagram relating to collection and provision of the sensing measurement data, in accordance with some embodiments of the disclosure; and

FIG. 5 is a flowchart relating to charging processing by a billing domain (BD), in accordance with some embodiments of the disclosure.

The figures are not exhaustive and do not limit the present disclosure to the precise form disclosed.

### DETAILED DESCRIPTION OF EMBODIMENTS

### Overview

It can be conceived to collect data from a user terminal or other apparatuses and provide the data or data obtained by processing the data to another user terminal or other apparatuses. As one example, the user terminal may be a mobile communication terminal, and the collected data may be sensing measurement data measured by the user terminal. In such a system, whether a user provides data, and the provision frequency, the accuracy, the importance level, and the like of the data provided by the user, depending on the user, can be determined. Therefore, it is desired to suitably grant an incentive to the user that has provided the data also in terms of improving the motivation for the data provision.

One aspect of the present disclosure is a network node configuring a wireless communication network. The network node comprises a processor. The network node is characterized in that: the processor executes: receiving a charging data request; and generating a charging data record in response to the reception of the charging data request; and the charging data record comprises a data identifier of data provided by a data providing apparatus.

One example of the wireless communication network is a system using 5G, 4G, LTE, LTE-A, SUPER3G, IMT-Advanced, NR, and the like and a next-generation system expanded on the basis of the above. Other examples of the wireless communication network are IEEE 802.11 (Wi-Fi (®)), IEEE 802.16 (WiMAX (®)), IEEE 802.20, UWB, Bluetooth (®), and other systems, and next-generation systems expanded on the basis of the above. The wireless communication network may be a system obtained by combining a plurality of systems with each other.

In some examples, a data identifier of data provided by the data providing apparatus is included in the charging data record (“CDR”). A first charging data record is generated when data is provided by the data providing apparatus, and a second charging data record is generated when the data is used by a data using apparatus. Processing of transferring, providing, and/or paying an incentive to the user of the data providing apparatus in accordance with a usage record of the data becomes possible by generating charging data records in accordance with each of the data provision and the data usage and including the data identifier in those charging data records.

In this aspect, generating the charging data record may comprise: generating a first charging data record including the data identifier of the data provided by the data providing apparatus and an identifier of the data providing apparatus; and generating a second charging data record including a data identifier of data used by a data using apparatus. It becomes possible to grant an incentive to the user that provides data in accordance with the usage record by generating the first charging data record and the second charging data record as above.

The second charging data record may further comprise the identifier of the data using apparatus. It becomes possible to demand a cost according to data usage from the user of the data using apparatus by including the identifier of the data using apparatus in the second charging data record.

The charging data record may comprise the data identifier of the data provided by the data providing apparatus and the identifier of the data providing apparatus. In some examples, this can be understood to be a charging data record relating to data provision (first charging data record). The charging data record including the data identifier of the data used by the data using apparatus (second charging data record) can be understood to be a charging data record relating to data usage. The “data identifier of the data provided by the data providing apparatus” (e.g., first data identifier) and the “data identifier of the data used by the data using apparatus” (e.g., second data identifier) may correspond with each other and may refer to the same or different value. In some examples, the first data identifier and the second data identifier may be the same value when the data provided by the data providing apparatus is directly used by the data using apparatus, for example. When the data created on the basis of the data provided by the data providing apparatus is used by the data using apparatus, one or a plurality of first data identifiers may be associated to the second data identifier and the correspondence relationship may be recorded in the network node.

In some examples, paying an incentive to the user of the data providing apparatus that has provided data becomes possible by including the data identifier of the data provided by the data providing apparatus and the identifier of the data providing apparatus in the charging data record. In some examples, demanding a fee from the user of the data using apparatus that has used the data becomes possible by including the data identifier of the data used by the data using apparatus and the identifier of the data using apparatus in the charging data record. In some examples, paying an incentive in accordance with the usage record of the data to the user of the data providing apparatus becomes possible as a result of both of the charging data record relating to the provision of the data and the charging data record relating to the usage of the data existing. When the processing of demanding a fee from the user of the data using apparatus is unnecessary, the identifier of the data using apparatus does not necessarily need to be included in the CDR relating to data usage generated in accordance with the data usage by the data using apparatus.

In this aspect, the data may be sensing measurement data obtained by being sensed by the data providing apparatus. The sensing measurement data may be raw data obtained by the data providing apparatus or may be data processed by the data providing apparatus or other apparatuses on the basis of the raw data. One example of the processed data is the type, the position, the size, the moving speed, and the like of an object detected by the sensing.

In this aspect, the data identifier may be the identifier of the object included in the sensing measurement data. Regarding the identifier of the object, the same identifiers may be allocated to the same objects, or different identifiers may be allocated to the same objects for each measurement instance. The data identifier in the present disclosure can be understood to be the identifier of the sensing measurement in some examples.

In this aspect, each of the charging data request and the charging data record may comprise at least one of an importance level, a confidence level, or a rarity level of the data. As a result of the charging data record comprising this information, it becomes possible pay additional incentives to the user that has provided data with a higher importance level, confidence level, or rarity level. Therefore, it becomes possible to facilitate the provision of data with a high importance level, confidence level, or rarity level.

In this aspect, the charging data record generated by the network node may be transmitted to a billing domain from the network node regularly or in response to a request. The billing domain performs at least one of the processing of paying an incentive to the user of the data providing apparatus or the processing of demanding a fee of data usage from the user of the data using apparatus on the basis of the charging data record obtained from the network node.

Another aspect of the present disclosure is an information processing system including: a network node; and a billing domain. The information processing system is characterized in that: the network node comprises a processor that executes: receiving a charging data request; generating a charging data record in response to the reception of the charging data request; and transmitting the charging data record to the billing domain; the billing domain comprises a processor that executes: receiving the charging data record; and demanding processing or paying processing based on the charging data record; and each of the charging data request and the charging data record comprises an identifier of data provided by a data providing apparatus (e.g., user equipment (UE) or other device) and an identifier of the data providing apparatus or an identifier of data used by a data using apparatus and an identifier of the data using apparatus.

In this aspect, the processor of the billing domain may execute at least either of the demanding processing with respect to the user of the data providing apparatus or the paying processing with respect to the user of the data using apparatus.

In this aspect, the processor of the billing domain may execute: receiving a first charging data record according to provision of data by the data providing apparatus and a second charging data record according to usage of data by the data using apparatus; and paying processing with a respect to a user of the data providing apparatus that has provided data of the data identifier included in the second charging data record based on the data identifier.

In this aspect, each of the charging data request and the charging data record may further comprise at least one of an importance level, a confidence level, or a rarity level of the data, and paying of an amount of money in accordance with at least one of the importance level, the confidence level, or the rarity level of the data may be performed in the paying processing.

Yet another aspect of the present disclosure is a method executed by a network node configuring a wireless communication network. The method comprises: receiving a charging data request; and generating a charging data record in response to the reception of the charging data request. The method is characterized in that each of the charging data request and the charging data record comprises a data identifier of data provided by a data providing apparatus (e.g., the UE) and an identifier of the data providing apparatus or a data identifier of data used by a data using apparatus and an identifier of the data using apparatus.

The present disclosure further comprises a computer program for causing a computer to execute each step of the method, and a computer program for realizing the network node or the information processing system by a computer. The present disclosure further comprises a computer-readable storage medium having the computer program recorded thereon.

Examples of the present disclosure are described below with reference to the drawings. The description provides examples of embodiments described herein, and the present disclosure is not limited to the configuration described herein. For example, the present disclosure may be applied to a 5th generation mobile communication system, but the present disclosure may be applied to a mobile communication system of a 4th generation or generations after the 5th generation. The present disclosure may be applied to a mobile communication system defined by those other than the 3rd Generation Partnership Project (3GPP). For example, the present disclosure may be applied to a freely-selected wireless communication system or wired communication system other than the mobile communication system. The data provided or used by the user terminal may be sensing data measured by the user terminal, data that is measured by something other than the user terminal, or may be freely-selected data other than the sensing data.

### Configuration of Information Processing System

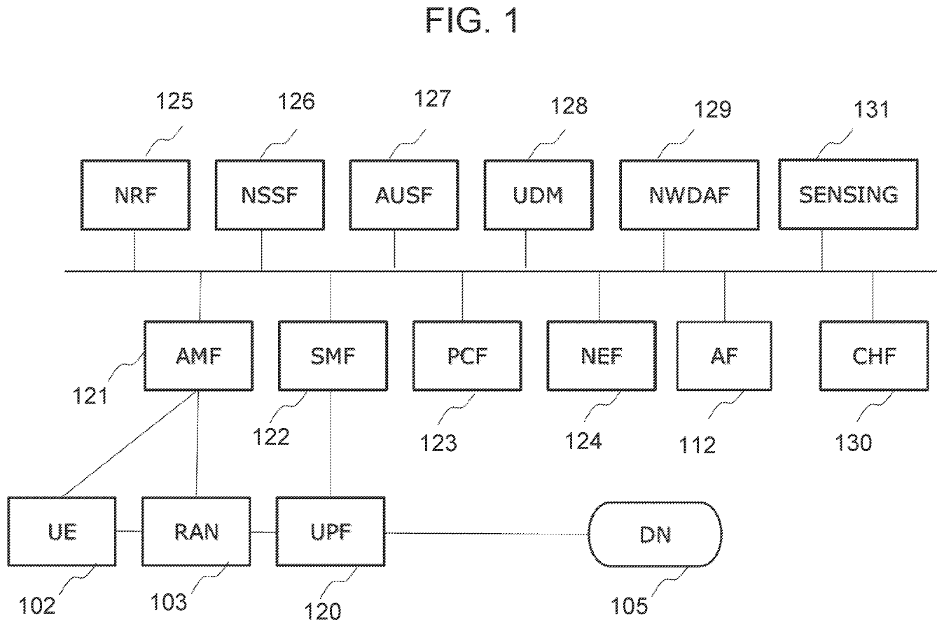

FIG. 1 shows components configuring a 5th generation mobile communication system (also referred to “5G network”). In FIG. 1, user equipment (UE) 102 is a terminal of a user (member). A radio access network (RAN) 103 is an access network to a 5G core network (also referred to as “5GC”). The RAN 103 is configured by a base station (also referred to as “gNB” or “gNodeB”). The 5G network has a 5G core network (also referred to “5GC”) and an access network ((R)AN), and a UE 102, a DN 105, and an AF 112 are connected to the 5G network.

The 5GC is configured by a set of the components having a predetermined function called a network function (NF). FIG. 1 shows various NFs configuring the 5GC, illustrated as NF 120-131. The NFs include, for example, user plane function (UPF) 120, access and mobility management function (AMF) 121, session management function (SMF) 122, policy control function (PCF) 123, network exposure function (NEF) 124, network repository function (NRF) 125, network slice selection function (NSSF) 126, authentication server function (AUSF) 127, unified data management (UDM) 128, network data analytics function (NWDAF) 129, charging function (CHF) 130, and sensing function (SENSING) 131.

Each of NFs is a function realized as a result of one or two or computers (information processing apparatuses) executing a program. However, a single computer may realize any two or more of the NFs 120-131. Each of the NFs 120-131 can be referred to as a network node or a network component.

The UPF 120 performs routing and forwarding of a user packet (a packet of a user plane transmitted and received by the UE 102), packet inspection, and QoS processing.

The AMF 121 is a location housing apparatus of the UE 102 in the 5GC. The AMF 121 houses the RAN 103 and performs member authentication control, position (mobility) management of the UE 102, and the like.

The SMF 122 manages a protocol data unit (PDU) session and controls the UPF 120 to perform quality of service (QOS) control and policy control. The PDU session is a virtual communication channel for exchanging data between the UE 102 and the data network (DN) 105. The DN 105 is a data network (the Internet and the like) outside the 5GC.

The PCF 123 performs QoS control, policy control, charging control, and the like under the control of the SMF 122. In the QoS control, the quality of communication of priority forwarding of a packet and the like is controlled. In the policy control, communication control such as charging, determination on whether the packet forwarding can be performed, and QoS based on network or member information is performed.

The NEF 124 has a role of mediating of communication between an external node and a node in a control plane.

The NRF 125 stores therein and manages information of the NFs (for example, AMF 121, SMF 122, and UPF 120) in the 5GC. The NRF 125 can reply with a plurality of NF candidates to an inquiry source in response to an inquiry according to an NF desired to be used.

The NSSF 126 has a function of selecting a network slice used by the member from network slices generated by network slicing. The network slice is a virtual network having specs depending on the purpose.

The AUSF 127 is a server for member authentication that performs member authentication under the control of the AMF 121.

The UDM 128 holds member-related information and provides member information or acquires, registers, deletes, and changes the state of the UE 102.

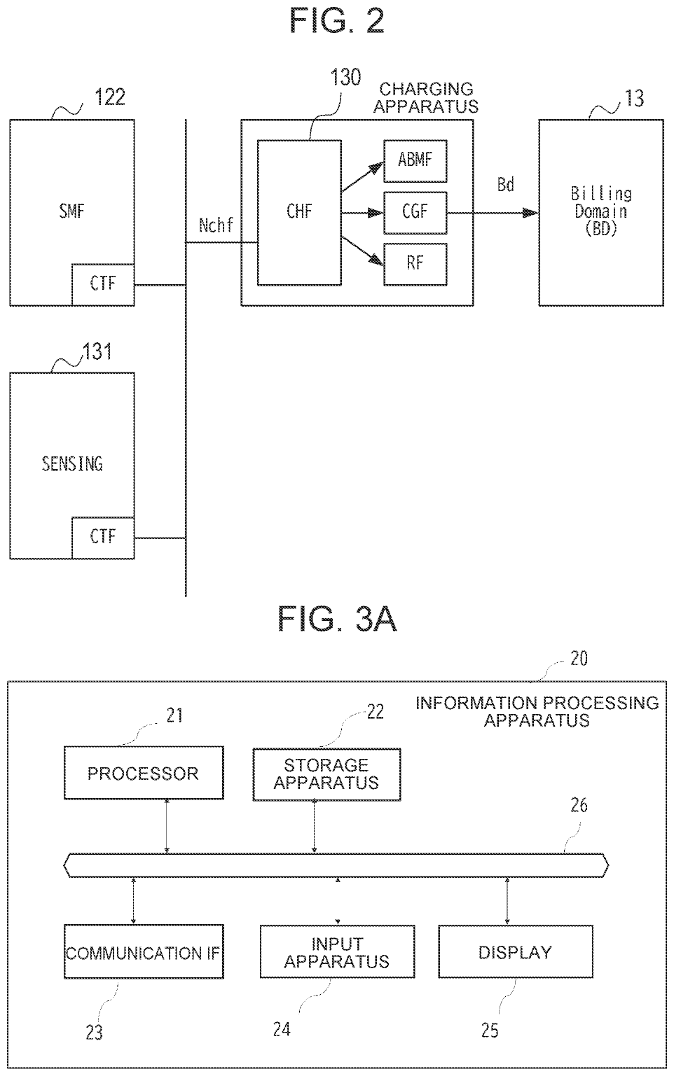

The NWDAF 129 has a function of collecting data from each NF 120-131 (as further described and illustrated in FIG. 2), an external server, and the like and performing analysis. The NWDAF 129 is an NF that provides analytical information of the network.

The CHF 130 is a network node having a function of online charging and offline charging. The CHF 130 is connected to a network node (NF) having a charging trigger function (CTF). Details of the CHF 130 are described below.

The SENSING 131 performs a sensing service including collecting sensing information from the UE 102, the RAN 103 (as configured by base station (gNB)), or other nodes, and providing the collected sensing information to the UE 102 or other external systems (the AF 112, the DN 105, and the like). Details of the SENSING 131 are described below.

The AF 112 is an NF that provides an application service via the NRF 125 as a part of the 5GC or an NF that is outside the 5GC and provides an application service via the NEF 124. The AF 112 performs processing using sensing data, for example. As one example, the AF 112 generates dynamic map information on the basis of sensing measurement data obtained from the SENSING 131. The UE 102 or an application program executed by the UE 102 may operate as the AF 112.

In the 5GC, a plurality of NFs of the same type may be prepared. For example, the NF 120-131 may be prepared for each data center (station). One NF 120-131 may be shared between data centers. The plurality of NFs 120-131 of the same type may be configured by one data center. The number of data centers, the number of the NFs 120-131, and the correspondence relationship between the NF 120-131 and the data center can be set, as appropriate.

FIG. 2 is a diagram describing the CHF 130 in more detail. The CHF 130 provides a service with use of an Nchf interface. For example, the PCF 123 interacts with CHF 130 using Nchf interface for Spending Limit Control. CTFs included in the SMF 122 and the SENSING 131 can access the CHF 130 with use of the Nchf interface.

As shown in FIG. 2, the CHF 130 can communicate with a billing domain 13 (BD, demanding apparatus) with use of a charging gateway function (CGF). The CHF 130 may configure a charging apparatus by being combined with an account balance management function (ABMF) and a rating function (RF). In the example of FIG. 2, the CGF is included in the charging apparatus, but the CGF may be included in the billing domain or may be a network element independent of both of the charging apparatus and the billing domain.

The sensing unit (SENSING) 131 is a network node having a function of collecting sensing measurement data from the UE 102, performing analysis processing of the sensing measurement data, and providing the sensing data to the AF 112. “Sensing data” in the present disclosure is a term including at least either of sensing measurement data itself provided from the UE 102 or data based on the provided sensing measurement data (for example, data or an analytical result obtained by analyzing the sensing measurement data). The SENSING 131 comprises a charging trigger function (CTF), and the CTF asks the CHF 130 to generate a CDR. The SENSING 131 accepts designation of sensing from the AF 112 that is a data request source, in particular, the specified NF 120-131 and the like via the NEF 124 and collects sensing information from the designated monitoring target, for example. Then, the SENSING 131 provides a notification regarding the collected sensing data to the AF 112 and the like for which designation has been accepted. The SENSING 131 can collect sensing measurement data from at least one of the AF 112 connected to the 5GC via the NEF 124, the RAN 103 (gNB), the external server, the UE 102, and the NF 120-131 other than the specified NF 120-131 described above. The sensing service by the SENSING 131 can be performed by one of a subscribe/notify method and a request/response method (similar to the regulation in TS23.288 Chapter 6.1).

The billing domain 13 (BD) is a network node having a function of performing charging (billing) processing. “Charging” in the present disclosure is a term of a meaning including at least either of granting an incentive (paying a fee) or collecting a fee (demanding a fec). The BD 13 receives a CDR from the CHF 130 and performs charging mediation (billing mediation), charging (billing), and other processing (for example, statistical processing).

### Configuration of Information Processing Apparatus and Terminal

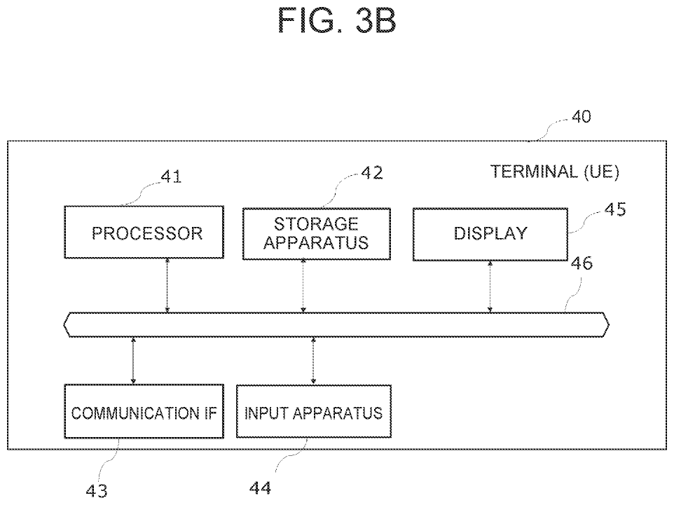

FIG. 3A is a diagram showing a configuration example of an information processing apparatus capable of operating as each of the NFs 120-131. In FIG. 3A, the information processing apparatus 20 can be configured as a dedicated or general-purpose information processing apparatus (computer) such as a personal computer (PC), a work station (WS), or a server machine. Needless to say, the information processing apparatus 20 may be an aggregation (cloud) of one or two or more computers.

The information processing apparatus 20 comprises a processor 21, a storage apparatus 22, a communication interface 23 (communication IF 23), an input apparatus 24, and a display 25 serving as a processing unit or a control unit (controller) connected to each other via a bus 26.

The storage apparatus 22 comprises a main storage apparatus and an auxiliary storage apparatus. The main storage apparatus is used as at least one of a storage region of a program and data, an expansion region of the program, a working region of a program, a buffer region of communication data, and the like. The main storage apparatus is configured by a random access memory (RAM) or a combination of a RAM and a read only memory (ROM). The auxiliary storage apparatus is used as a storage region of data and a program. A non-volatile storage medium is applied to the auxiliary storage apparatus. The non-volatile storage medium is a hard disk, a solid state drive (SSD), a flash memory, or an electrically erasable programmable read-only memory (EEPROM), for example. The storage apparatus 22 can comprise a drive apparatus of a disc recording medium.

The communication IF 23 is a circuit that performs communication processing. For example, the communication IF 23 is a network interface card (NIC). The communication IF 23 may be a wireless communication circuit that performs wireless communication (e.g., via 5G, a wireless LAN (Wi-Fi (R)), BLE, and the like). The communication IF 23 may be a combination of a circuit that performs wired communication processing and a wireless communication circuit.

The input apparatus 24 comprises a key, a button, a pointing device, a touch screen, and the like and is used in the input of information. The display 25 is a liquid crystal display, for example, and displays information and data.

The processor 21 performs various processing by executing various programs stored in the storage apparatus 22. When the processor 21 executes the programs stored in the storage apparatus 22, the information processing apparatus 20 can operate as each of the NFs 120-131.

FIG. 3B is a diagram showing a configuration example of a terminal 40 operatable as the UE 102. The terminal 40 comprises a processor 41, a storage apparatus 42, a communication interface 43 (communication IF 43), an input apparatus 44, and a display 45 connected to each other via a bus 46. As the processor 41, the storage apparatus 42, the communication IF 43, the input apparatus 44, and the display 45, those similar to the processor 21, the storage apparatus 22, the communication IF 23, the input apparatus 24, and the display 25 can be used. Therefore, description of the processor 41, the storage apparatus 42, the communication IF 43, the input apparatus 44, and the display 45 is omitted.

The processors 21 (in FIG. 3A) and 41 (in FIG. 3B) are central processing units (CPUs), for example. The CPU is also referred to as a microprocessor unit (MPU). The processors 21 and 41 may have a single processor configuration or a multiprocessor configuration. A single physical CPU connected by a single socket may have a multicore configuration. The processors 21 and 41 may comprise arithmetic units having various circuit configurations such as a digital signal processor (DSP) or a graphics processing unit (GPU). The processors 21 and 41 may have a configuration that works together with at least one of an integrated circuit (IC), other digital circuits and analog circuits, and the like. The integrated circuit comprises a Large-Scale Integration (LSI), an application specific integrated circuit (ASIC), a programmable logic device (PLD), and the like. The PLD comprises a field-programmable gate array (FPGA), for example. The processors 21 and 41 also comprise a so-called microcontroller (MCU), system-on-a-chip (SoC), system LSI, or chipset, for example.

### Operation Example: Data Collecting and Providing Processing

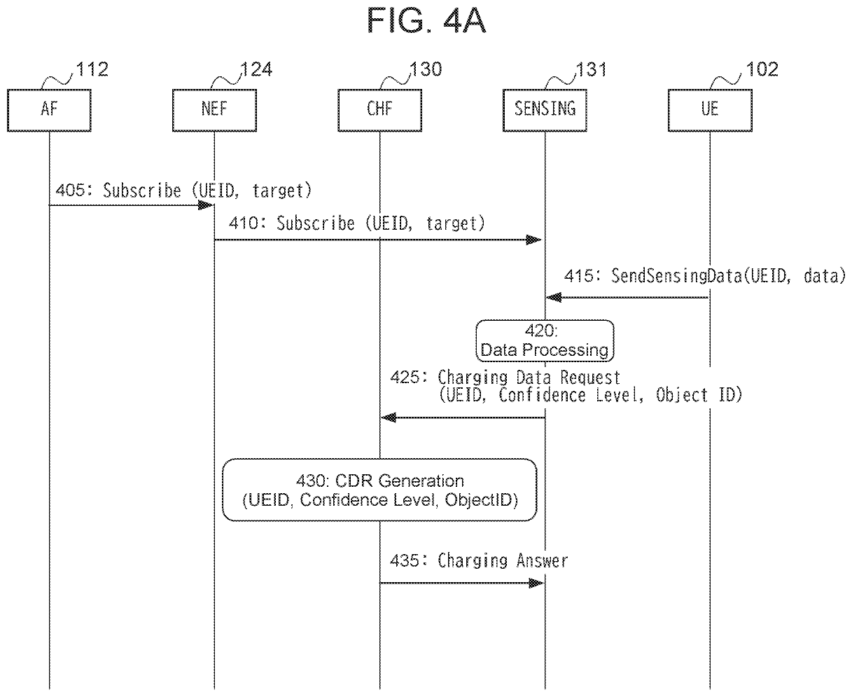

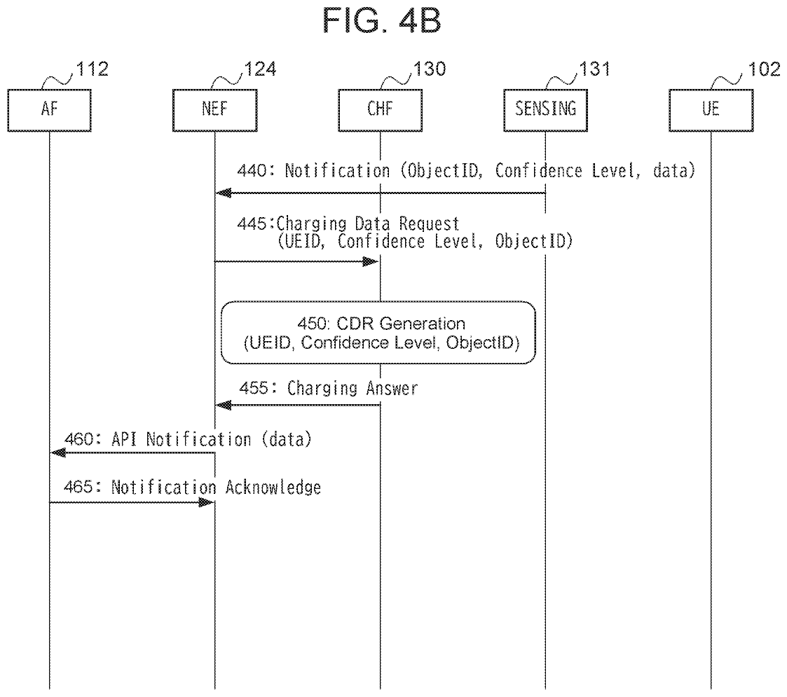

FIG. 4A to FIG. 4B are sequence diagrams showing examples of operation relating to collecting and providing sensing data in an aspect of the present disclosure. Each of the sequence diagrams shown here is one example and may include processing other than those shown, some of the shown processing may be omitted, or the execution order of the shown processing may be changed. In FIG. 4A to FIG. 4B, an example of providing data by a subscribe/notify method is described, but data may be provided with use of a request/response method. In FIG. 4A to FIG. 4B, offline charging is presupposed but online charging may be employed.

In this operation example, the UE 102 that transmits sensing data to the SENSING 131 is one example of a “data providing apparatus”, and the AF 112 that is provided with the sensing data from the SENSING 131 is one example of a “data using apparatus”.

In blocks 405 and 410, the AF 112 that uses the sensing data performs subscription (subscribe) of the sensing data with respect to the SENSING 131 via the NEF 124. A subscription message comprises the identifier of the AF 112 and a parameter for specifying the sensing data of the subscription target. The identifier (AF ID) of the AF 112 (e.g., as an external server) is used as an identifier (e.g., transmitted and stored as “UE ID”) for specifying a data user (e.g., operating as a subscriber of the network) in the data collecting and providing processing. The parameter for specifying sensing measurement data of a subscription target may be expressed as conditions relating to the type, the existing position, the moving speed, the size, and the like of an object, for example. The subscription message from the AF 112 is transmitted to the SENSING 131 via the NEF 124. In some examples, the parameters included in the subscription messages in blocks 405 and 410 are the same, but the NEF 124 may change the parameters included in the subscription messages, for example.

In block 415, the UE 102 that provides sensing measurement data transmits the sensing measurement data to the SENSING 131. In a data transmission message, an identifier of the UE 102 and the sensing measurement data are included. Here, the sensing measurement data may be raw data of the sensing measurement performed by the UE 102 or may be data processed from the raw data.

In block 420, the SENSING 131 performs data processing of the sensing measurement data received from the UE 102. An example of the data processing is processing of specifying the target of sensing measurement included in the sensing measurement data. The specification of the target comprises object recognition (recognition of the object type), position specification, size specification, the moving speed specification, and the like. The SENSING 131 also obtains an object identifier (object ID) that specifies the target included in the sensing measurement data. For example, each time sensing measurement data is obtained, the SENSING 131 allocates a unique identifier for an object obtained from the sensing measurement data.

The SENSING 131 may also obtain a confidence level of the object recognition. The object recognition can be typically performed with use of a learning model (object recognition means) obtained by machine learning. With a result of the object recognition, the learning model also outputs a confidence level of the result. The confidence level output from the learning model or a value based on the confidence level is equivalent to the confidence level of the object recognition described above.

The SENSING 131 may obtain a rarity level (rarity, scarcity) of the sensing measurement data. The rarity level can be determined by various viewpoints. As one example, it can be conceived to determine objects with less frequency of appearance or frequency of detection to have a higher rarity level, and determine sensing measurement data in positions and/or time periods in which the number or frequency by which sensing measurement data is obtained is less to have a higher rarity level. For example, the SENSING 131 counts the type of the objects included in the sensing measurement data, the position of the measurement target, the time periods, and/or the like that have been obtained so far and calculates the rarity level of each sensing data in accordance with the number of data or the appearance frequency.

The SENSING 131 may obtain an importance level of the sensing data. The importance level may be determined as an average or a total, for example, by combining the confidence level and the rarity level, for example, or may be determined on the basis of other standards.

The SENSING 131 saves the result of the data processing in the storage apparatus.

In block 425, the SENSING 131 transmits a charging data request to the CHF 130. The charging data request comprises information with which it can be specified that the charging data request relates to the provision of data. The charging data request comprises the identifier of the UE 102 that has provided data, the confidence level of the sensing data, and the identifier of the object included in the sensing data.

In block 430, the CHF 130 generates a charging data record (CDR) in response to the reception of the charging data request. The CDR comprises information with which it can be specified that the CDR relates to the data provision from the UE 102. The CDR comprises the identifier of the UE 102 that has provided data, the confidence level of the sensing data, and the identifier of the object included in the sensing data. The generated CDR is saved in the storage apparatus in the CHF 130.

In block 435, the CHF 130 transmits a notification (charging answer) indicating that the generation of the CDR has completed to the SENSING 131.

The process continues at FIG. 4B, at block 440, the SENSING 131 transmits the sensing data to the NEF 124 (e.g., transmitted as an electronic notification). The processing in block 440 may be executed in response to the SENSING 131 acquiring the sensing data of a target for which the NEF 124 has applied for a subscription. The notification message comprises an object identifier, a confidence level of a sensing data, and the sensing data. The sensing data transmitted to the NEF 124 may be a result obtained by the SENSING 131 by data processing instead of or in addition to the sensing measurement data provided from the UE 102.

In block 445, the NEF 124 transmits a charging data request to the CHF 130. The charging data request comprises an identifier of the AF 112 that is a data providing destination (subscriber), the confidence level of the sensing data, and the identifier of the object included in the sensing data.

In block 450, the CHF 130 generates a charging data record (CDR) in response to the reception of the charging data request. The CDR comprises information with which it can be specified that the CDR relates to data usage by the AF 112. The CDR comprises an identifier of the AF 112 that is the data providing destination, the confidence level of the sensing data, and the identifier of the object included in the sensing data. The generated CDR is saved in the storage apparatus in the CHF 130.

The identifier of the AF 112 that is the data providing destination is included in the CDR in order to demand a cost from the user of the AF 112. When a cost is not demanded from the user of the AF 112, specification of the user that has used the data is unnecessary, and hence the data usage CDR does not necessarily need to include the identifier of the user.

In block 455, the CHF 130 transmits a notification (charging answer) indicating that the generation of the CDR has completed to the SENSING 131.

In block 460, the NEF 124 transmits the sensing measurement data to the AF 112 (e.g., transmitted to an API as an electronic notification). The message at least comprises the sensing data.

In block 465, the AF 112 transmits a notification indicating that the sensing data is received to the NEF 124 (e.g., transmitted as an electronic notification acknowledge).

### Operation Example: Charging Processing

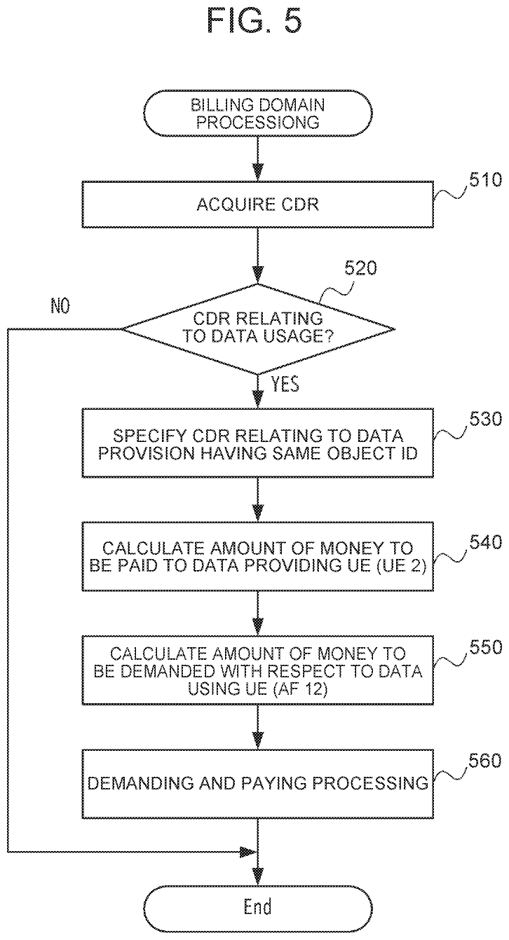

FIG. 5 is a flowchart showing a flow of the charging processing relating to provision and usage of the sensing measurement data executed by the BD 13 (billing domain; charging apparatus). The example of FIG. 5 is the flowchart of the charging processing when the amount of money of the incentive to be paid to the user of the data providing UE is determined in accordance with a usage record of the data.

In block 510, the BD 13 acquires a CDR from the CHF 130. The processing of providing the CDR to the BD 13 from the CHF 130, in other words, receiving the CDR from the CHF 130 by the BD 13 may be regularly performed or may be performed on the basis of a transmission request from the BD 13.

In some examples, the processing in blocks 520-560 is performed for each acquired CDR.

In block 520, the BD 13 determines whether the CDR relates to data usage. When the CDR relates to data usage, the processing proceeds to block 540. The CDR relating to data usage is also referred as a data usage CDR below for the purpose of illustration.

In block 530, the BD 13 specifies a CDR having an object identifier (object ID) that is the same as an object identifier included in the CDR that is currently being processed out of acquired CDRs. The CDR relating to data provision is also referred as a data provision CDR below for the purpose of illustration. By specifying the data provision CDR, the UE 102 that has provided data used by the AF 112 (or data used in the processing of the data) can be determined. Instead of searching the corresponding data provision CDR from the acquired CDR, the BD 13 may inquire the CHF 130 for a corresponding CDR at the time point and acquire the CDR.

In block 540, the BD 13 calculates the amount of money to be paid to the UE 102 that has provided the data. The amount of money to be paid may be determined in accordance with the confidence level of the provided sensing data and specifically the confidence level included in the data provision CDR, for example. The amount of money to be paid may be determined on the basis of other parameters such as the importance level and the rarity level of the sensing data. The amount of money to be paid may be determined on the basis of a contribution level of the UE 102 in data provision to the AF 112. The contribution level of the UE 102 may be determined by a contribution rate of the data provided by the UE 102 out of the data used in the creation of the data provided to the AF 112, for example. The contribution rate may be determined as a rate of sensing data by the UE 102 out of the sensing data used in data creation. This rate may be a simple rate based on numbers, or may be a weighting rate (weight ratio) using weight based on at least one of the confidence level, the rarity level, and the importance level.

In block 550, the BD 13 calculates the amount of money to be demanded from the user of the AF 112 that has used data. The amount of money to be demanded may be determined in accordance with the confidence level of the sensing data or may be a fixed amount of money, for example.

In block 560, the BD 13 executes the paying processing with respect to the UE 102 and the demanding processing with respect to the AF 112.

The amount of money of the incentive to be paid may be determined by procedures other than the above. For example, an incentive may be paid when the provided data satisfies a predetermined standard regardless of the data usage record. In this case, the amount of money to be paid may be a fixed amount or may be a variable amount in accordance with the degree of conformance with the standard.

### Technical Advantageous Effects of the Present Disclosure

According to the present embodiment, a usage record of data and a UE that has provided sensing data are linked to each other by storing an object identifier in a CDR relating to the provision and the usage of the sensing measurement data. Therefore, it becomes possible to pay an incentive to the data providing UE (e.g., UE 102) in accordance with the usage record of the sensing data. By determining the amount of the incentive (amount of money to be paid) in accordance with the confidence level of the sensing measurement data, the motivation for the user of the UE to provide sensing measurement data with a higher confidence level improves.

By the above, more sensing measurement data with a higher confidence level is provided from the user terminal. When more sensing measurement data with a higher confidence level is obtained, a service that is more useful can be provided to the AF 112, and the convenience for the user that uses the service is also obtained.

### Other Modified Examples

The embodiment described above is merely one example, and the present disclosure may be embodied by being changed, as appropriate, without departing from the gist of the present disclosure.

In the embodiment described above, the data provided and used by the user terminal is sensing data measured by the user terminal. However, the data to be provided and used may be sensing data measured by those other than the user terminal or may be freely-selected data other than the sensing data.

Data is provided to the user terminal by the subscribe/notify method in the embodiment described above, but data may be provided to the user terminal by a request/response method.

An incentive is granted to data provision and a cost is demanded for data usage in the embodiment described above, but a cost does not necessarily need to be demanded for data usage. When a cost is not demanded for data usage, the generation of a CDR relating to data usage (e.g., at block 450) does not necessarily need to be performed, but a CDR relating to data usage may be generated in order to grant an incentive in accordance with a usage record of the data. When an incentive in accordance with the usage record of the data is simply granted, the specification of the user terminal that has used the data is unnecessary, and hence the identifier of the second user terminal does not necessarily need to be included in the data usage CDR.

It is also possible to realize the present disclosure by supplying a computer program in which the functions described in the embodiment are implemented to a computer and causing one or more processors of the computer to read out and execute the program. Such a computer program may be provided to the computer by a non-transitory computer-readable storage medium connectable to a system bus of the computer or may be provided to the computer via a network. Examples of the non-transitory computer-readable storage medium comprises any type of disks or discs such as a magnetic disk (a floppy® disk, a hard disk drive (HDD), and the like) and an optical disc (a CD-ROM, a DVD disc, a Blu-ray disc, and the like), a read-only memory (ROM), a random access memory (RAM), an EPROM, an EEPROM, a magnetic card, a flash memory, an optical card, and any type of medium suitable for storing therein an electronic instruction, for example.

What is claimed is:

1. An information processing system, comprising:
a network node; and
a billing domain, wherein:
the network node comprises a first processor configured to execute receiving a charging data request,
generating a charging data record in response to receiving the charging data request, and
transmitting the charging data record to the billing domain,
the billing domain comprises a second processor configured to execute processing of receiving the charging data record, and
demanding processing or paying processing based on the charging data record, and
the charging data record comprises a data identifier of data provided by a data providing apparatus.

2. The information processing system according to claim 1, wherein the generating the charging data record comprises:
generating a first charging data record including the data identifier of the data provided by the data providing apparatus and an identifier of the data providing apparatus; and
generating a second charging data record including a data identifier of data used by a data using apparatus.

3. The information processing system according to claim 1, wherein the second charging data record further comprises an identifier of the data using apparatus.

4. The information processing system according to claim 1, wherein the second processor of the billing domain is configured to execute paying processing for a user of the data providing apparatus.

5. The information processing system according to claim 4, wherein the second processor of the billing domain is configured to execute:
processing of receiving a first charging data record according to provision of data by the data providing apparatus and a second charging data record according to usage of data by a data using apparatus; and
based on the data identifier included in the second charging data record, the processing of paying for the user of the data providing apparatus that has provided data of the data identifier.

6. The information processing system according to claim 5, wherein:
each of the charging data request and the charging data record further comprises at least one of an importance level, a confidence level, or a rarity level of the data; and
paying of an amount of money in accordance with at least one of the importance level, the confidence level, or the rarity level of the data is performed in the processing of paying.

7. A network node that configures a wireless communication network, comprising a processor configured to:
receive a charging data request; and
generate a charging data record in response to receiving the charging data request, wherein the charging data record comprises a data identifier of data provided by a data providing apparatus.

8. The network node according to claim 7, wherein the generating the charging data record comprises:
generating a first charging data record including the data identifier of the data provided by the data providing apparatus and an identifier of the data providing apparatus; and
generating a second charging data record including a data identifier of data used by a data using apparatus.

9. The network node according to claim 8, wherein the second charging data record further comprises an identifier of the data using apparatus.

10. The network node according to claim 7, wherein the data is sensing data obtained by performing sensing measurement by the data providing apparatus.

11. The network node according to claim 10, wherein the data identifier is an identifier of an object specified from the sensing data.

12. The network node according to claim 7, wherein each of the charging data request and the charging data record further comprises an importance level of the data.

13. The network node according to claim 7, wherein each of the charging data request and the charging data record further comprises a confidence level of the data.

14. The network node according to claim 7, wherein each of the charging data request and the charging data record further comprises a rarity level of the data.

15. The network node according to claim 7, wherein the processor is configured to transmit the charging data record to a billing domain regularly or in response to a request.

16. An information processing method executed by a network node configuring a wireless communication network, the information processing method comprising:
receiving a charging data request; and
generating a charging data record in response to receiving the charging data request, wherein the charging data record comprises a data identifier of data provided by a data providing apparatus.

17. A non-transitory storage medium storing instructions that are executable by a processor and that cause the processor to:
receive a charging data request; and
generate a charging data record in response to receiving the charging data request, wherein the charging data record comprises a data identifier of data provided by a data providing apparatus.
